(19) United States
(12) Patent Application Publication
(10) Pub. No.: US 2005/0066429 A1
(43) Pub. Date: Mar. 31, 2005

(54) Protective suit

(75) Inventors: Wai Choi Tang, Hong Kong (CN); Wilson Sai Mo Wong, Hong Kong (CN)

Correspondence Address: ALIX YALE & RISTAS LLP, 750 MAIN STREET, SUITE 1400, HARTFORD, CT, 06103, US

(73) Assignee: Winsource Industries Limited

(21) Appl. No.: 10/910,873

(22) Filed: Aug. 4, 2004

(30) Foreign Application Priority Data
Aug. 26, 2003 (HK) 03106106.5

(51) Int. Cl. A62B 17/00; A41D 13/00

(52) U.S. Cl. 2/457

(57) ABSTRACT

A protective suit has a hood and a body having a neck opening. An annular connector connects the hood to the neck opening and has an annular groove for receiving an edge portion of the hood and/or body. A band extends along the groove upon the edge portion(s) to seal the same securely within the groove.

### BACKGROUND OF THE INVENTION

Severe Acute Respiratory Syndrome (SARS) has killed many people in the world. Many victims are health care workers, such as doctors and nurses who contract the virus in hospitals. Existing protective suits are not completely sealed so that air can easily migrate into the suits and the health care workers are therefore exposed to the airborne virus.

The invention seeks to mitigate or at least alleviate such shortcomings by providing a protective suit having parts connected to one another in a sealed manner.

### SUMMARY OF THE INVENTION

According to the invention, there is provided a protective suit comprising a body having a neck opening and a hood. An annular connector connects the hood to the neck opening and has an annular groove for receiving an edge portion of the hood and/or body. A band extends along the groove upon the edge portion(s) to seal the same securely within the groove. Preferably, the suit has a pair of gloves and the body has a pair of wrist openings. Another annular connector is relatively smaller in diameter and connects the glove to the wrist opening. The connector has an annular groove for receiving an edge portion of the glove and/or body. Another band can extend along the groove upon the edge portion(s) to seal the same securely within the groove.

Preferably, the annular connector has two grooves for respectively locating and holding an edge portion of the hood/glove and an edge portion of the body.

Preferably, the connector is made of plastics material for long lasting use and easy cleaning.

### BRIEF DESCRIPTION OF DRWAINGS

A preferred embodiment of the present invention will now be described by way of example with reference to the accompanying drawings, in which:

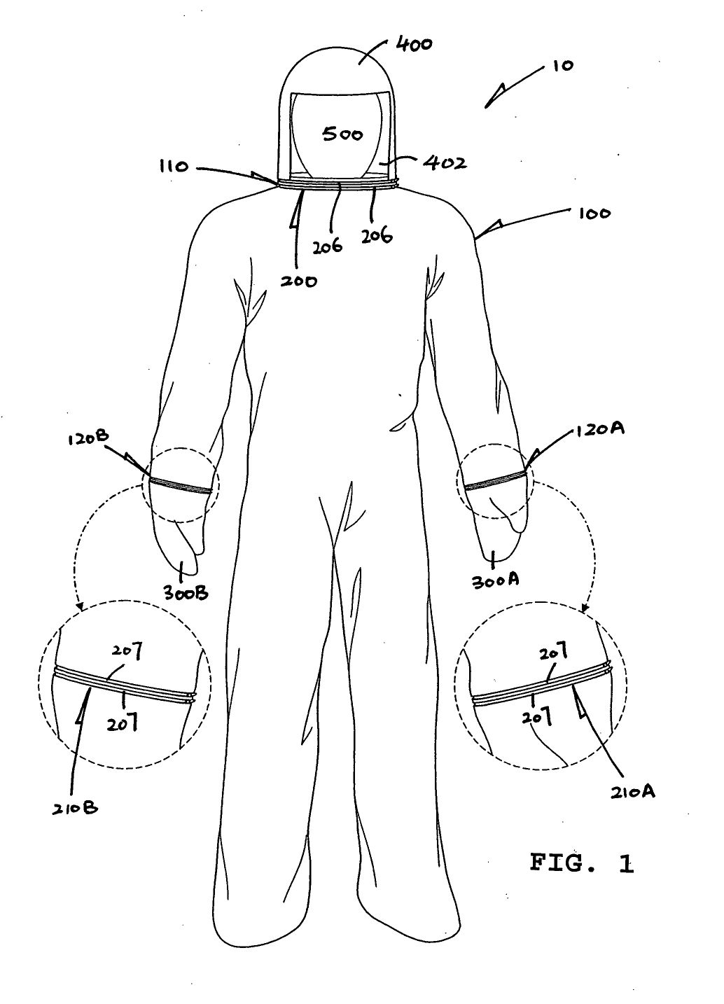

FIG. 1 is a front view of a protective suit;

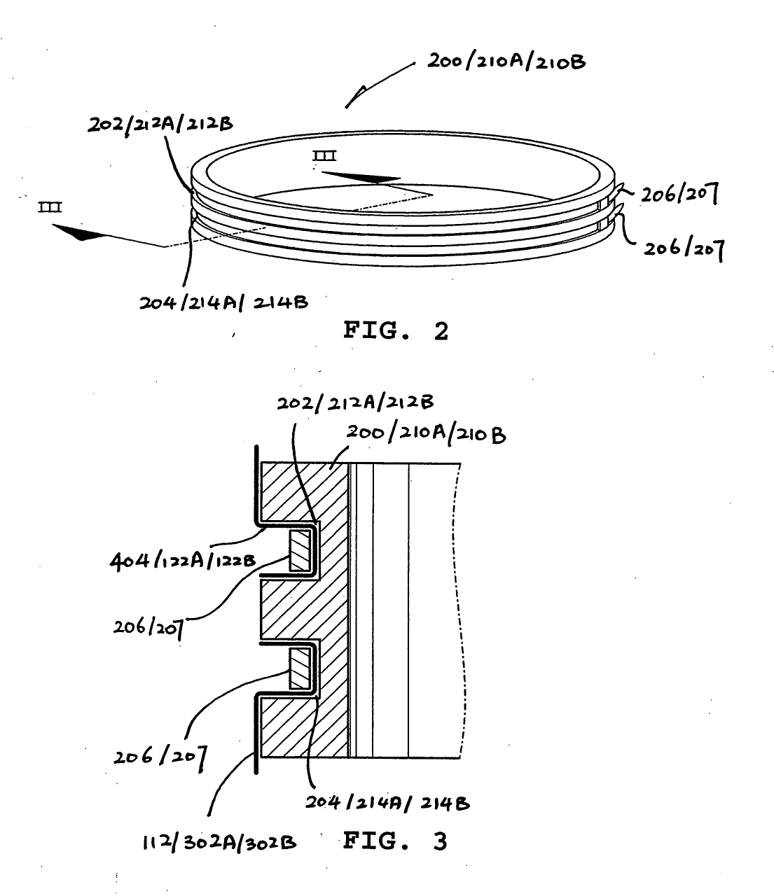

FIG. 2 is an enlarged view of a ring-shaped connector of the protective suit of FIG. 1; and

FIG. 3 is a cross-sectional view of the ring-shaped connector of FIG. 2.

### DETAIL DESCRIPTION OF PREFERRED EMBODIMENT

Referring to the drawings, there is shown a protective suit 10 having a human torso-shaped body 100 made of flexible air-impermeable sheet material, a pair of arms and a pair of legs. The body 100 has a neck opening 110 and a pair of wrist openings 120A and 120B.

A hood 400 for protecting a wearer's head 500 is provided at the neck opening 100. The hood 400 has a transparent front part 402 so that the wearer can see.

A pair of gloves 300A and 300B protect the wearer's hands. One glove is attached at the wrist opening 120A and the other one is attached at the wrist opening 120B.

A ring-shaped connector 200 connects the hood 400 to the neck opening 110. The connector 200 has two annular grooves 202 and 204. The grooves 202 and 204 receive and hold an edge portion 404 of the hood 400 and an edge portion 112 the neck opening 110 respectively. A band 206 extends along each groove 202/204 upon the edge portion to seal the same securely within the groove 202/204. The band 206 might take the form of a hose clamp or elastic strip for example.

A pair of similar ring-shaped connectors 210A and 210B being relatively smaller in diameter each connect one of the wrist openings 120A/B to glove 300A/B. The connectors 210A/B also have two annular grooves 212A/B and 214A/B. The grooves 212A/B and 214A/B receive and hold an edge portion 122A/B of the wrist opening 120A/B and an edge portion 302A/B of the glove 300A/B respectively. Another band 207 extends along each groove 212/214 upon the edge portion to seal the same securely within the groove 212/214. Each band can be in the form of a hose clamp or elastic strip for example.

Once all the connections have been well established, the wearer inside the suit is completely sealed and air cannot migrate into the suit such that the wearer is protected from any direct contact with outside air.

As air cannot directly migrate into the suit, it is necessary for the wearer to have air inside the suit 50 to enable breathing. An external air supply tank or air pump (not shown) having an air disinfection filter can be attached to the suit 10 to supply disinfected air to the wearer. The suit 10 would also be provided with an air exhaust having an exhausted air disinfection filter therein.

The invention has been given by way of example only, and various modification of and/or alterations to the described embodiment may be made by persons skilled in the art without departing from the scope of the invention as specified in the appended claims.

1. A protective suit comprising:
a body having a neck opening;
a hood;
an annular connector for connecting the hood to the neck opening and having an annular groove for receiving an edge portion of the hood and/or body; and
a band extending along the groove upon the edge portion(s) to seal the same securely within the groove.

2. The protective suit as claimed in claim 1, wherein the suit has a pair of gloves and the body has a pair of wrist openings, another annular connector is relatively smaller in diameter and connects the glove to the wrist opening and has an annular groove for receiving an edge portion of the glove and/or body.

3. The protective suit as claimed in claim 2, wherein another band extends along the groove upon the edge portion(s) to seal the same securely within the groove.

4. The protective suit as claimed in claim 1, wherein the annular connector has two grooves for respectively locating and holding an edge portion of the hood/glove and an edge portion of the body.

5. The protective suit as claimed in claim 1, wherein the connector is made of plastics material for long lasting use and easy cleaning.

6. The protective suit as claimed in claim 2, wherein the annular connector has two grooves for respectively locating and holding an edge portion of the hood/glove and an edge portion of the body.

7. The protective suit as claimed in claim 2, wherein the connector is made of plastics material for long lasting use and easy cleaning.
